(19) United States
(12) Patent Application Publication
(10) Pub. No.: US 2009/0258308 A1
(43) Pub. Date: Oct. 15, 2009

(54) Toner and Method of Preparing the Same

(75) Inventors: Jong Chull PARK, Suwon-si (KR); Mi Sun KIM, Suwon-si (KR); Kyung Hyun BAEK, Goyang-si (KR); Jin Gyu PARK, Seoul (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: Cheil Industries Inc., Gumi-si (KR)

(21) Appl. No.: 12/487,067

(22) Filed: Jun. 18, 2009

Related U.S. Application Data
(63) Continuation-in-part of application No. PCT/KR2006/005579, filed on Dec. 19, 2006.

(30) Foreign Application Priority Data
Dec. 19, 2006 (KR) 2006-129833

(51) Int. Cl. G03G 9/08

(52) U.S. Cl. 430/108.1; 430/110.2; 430/137.14

(57) ABSTRACT

The present invention provides a toner having a core-shell structure which is formed by aggregation-coalescence of latex particles having bimodal particle size distribution. The toner according to the present invention can prevent scattering and image offset by enhancing adhesiveness and charge-up rate. The toner can also have controlled particle morphology of the particles and a uniform particle size distribution.

### CROSS-REFERENCE TO RELATED APPLICATIONS

This non-provisional application is a continuation-in-part application of PCT Application No. PCT/KR2006/005579, filed Dec. 19, 2006, pending, which designates the U.S. and which is hereby incorporated by reference in its entirety, and claims priority therefrom under 35 USC Section 120. This application also claims priority under 35 USC Section 119 from Korean Patent Application No. 10-2006-0129833, filed Dec. 19, 2006, the entire disclosure of which is also hereby incorporated by reference.

### FIELD OF THE INVENTION

The present invention relates to a toner and a method of preparing the same.

### BACKGROUND OF THE INVENTION

Electrophotography and electrostatic recording processes use a developer to make an electrostatic image or electrostatic latent image visible. Developers include two-component developers with toner and carrier particles, one-component developers with toner without carrier particles, and 1.5-component developers in which carrier particles are involved only in development.

One-component developers include magnetic one-component developers containing a magnetic material and non-magnetic one-component developers without a magnetic material. Non-magnetic one-component developers can include suitable organic or inorganic particles such as fumed silica to enhance the fluidity of the toner. This type of toner can also include colored particles obtained by dispersing a colorant, such as carbon black or an organic and inorganic dye, and a charge control agent in a binder resin.

Toner including fluidity enhancing additives, however, can suffer scattering problems due to insufficient static electricity and lack of durability. The molecular weight or gel content of latex particles of the toner component can be increased to improve the durability of the toner so that the toner will not adhere to doctor blades, but this can also decrease fixability.

Methods for preparing toner can be broadly divided into pulverization, or grinding, methods and polymerization methods.

In pulverization methods, the toner can be obtained by melt-mixing a binder resin, colorant, and optionally other additives, grinding the mixture, and then sorting or classifying the resultant particles to provide particles with a desired particle size. This pulverization method can also be referred to as a “break-down method” because it grinds large melt-mixed particles into microsized particles that function as toner.

In polymerization methods, a polymerizable monomer composition can be prepared by homogenously dissolving or dispersing polymerizable monomers, colorant, polymerization initiators, and optionally various additives such as a cross-linking agent and an antistatic agent. Then the polymerizable monomer composition may be dispersed in an aqueous dispersion medium containing a dispersion stabilizer by a mixer so as to form fine droplet particles of the polymerizable polymer composition. Then the dispersion may be heated to initiate suspension polymerization to obtain the desired sized colored polymer toner particles.

An image forming apparatus such as an electronic photographic apparatus or an electrostatic recording apparatus forms an electrostatic latent image by exposing an image on a uniformly charged photoreceptor, creates a toner image by adhering toner to the electrostatic latent image, transcribes (or transfers) the toner image to a transfer material like transcription paper, and subsequently fixes the unfixed toner image to the transfer material by heating, pressurization and the like. In the fixation step, generally, the transfer material with the toner image passes between a fixing roll and a pressing roll and the toner is melt-fixed to the transfer material by heating and pressing.

An image forming apparatus such as an electrophotocopier should precisely and accurately form images. Conventionally, image forming apparatus use a toner manufactured by pulverization. It can be difficult, however, to precisely control particle size or particle size distribution when manufacturing a toner suitable for electrophotographic or electrostatic recording processes using a conventional melt-mixing and grinding process, and the resultant colored particles can have a broad particle size distribution. Therefore, to provide satisfactory developing properties, it is necessary to narrow the range of the particle size distribution by sorting or classifying the pulverized particles. The sorting process used to prepare toner with a small particle size, however, lowers yield. In addition, pulverization methods are limited with regard to design modifications and/or toner adjustments that can be made to control charging and fixing properties of the toner. Accordingly, polymerization methods have drawn recent attention because polymerization methods may allow easy control of particle size and may eliminate complex sorting steps.

Recently, particle spherization to increase pulverization and sorting yields, and mechanical fusing and heat surface-fusing have been developed to improve grinding methods for manufacturing toner to compete with polymerization methods. However, such methods still cannot achieve small toner particles or comply with the particle structure design which is a fundamental benefit of polymerization. Therefore, polymerized toner is drawing more attention.

Manufacturing a toner by a polymerizing method can allow the production of polymerized toner having a desired particle size and particle size distribution without grinding or sorting.

U.S. Pat. No. 6,033,822 discloses a process for producing a polymerized toner having a core-shell structure by suspension polymerization. However, it is difficult to control the particle size and shape of the toner using this method. In addition, the method results in a broad particle size distribution.

A recently adopted toner polymerization method is emulsion aggregation. Emulsion aggregation can allow easy control of the shape and size of toner. Emulsion aggregation uses a separate latex to form a shell encapsulating toner particles to provide a core-shell structure. The shell can minimize the adverse effect of toner components, such as dyes, wax and charge control agents. However, using separate latex particles to encapsulate toner particles complicates the process, and the aggregation-coalescence of the latex to form the shell surrounding the toner particles may deteriorate the distribution of particle sizes by inducing adhesion of desirable sized particles to one another.

Consequently, the poor distribution of particle sizes in turn may result in scattering, counter-charged toner, and decreased image resolution, among other problems.

### SUMMARY OF THE INVENTION

The present inventors have developed a toner and a method of making the same, which uses latex particles having a bimodal particle size distribution. The toner can have a broad fusing latitude, enhanced fixation properties and improved charge-up rate. The toner accordingly can improve image quality by preventing scattering, minimizing image offset, and providing high image resolution, even at low fixation temperatures. Further, it can be easy to control the morphology of the particles and to provide a uniform particle size distribution during an aggregation-coalescence step.

Accordingly, one aspect of the invention provides a toner having a core-shell structure prepared by an aggregation-coalescence process using latex particles having a bimodal particle size distribution.

Another aspect of the invention provides a method for preparing the foregoing toner. The method comprises the step of aggregation-coalescence of the latex particles having a bimodal particle size distribution with a colorant and a wax. The method of the invention can eliminate the need for a separate step of preparing a latex for the shell of the toner, as well as eliminate the need for a separate step of adding the latex to form the shell. The method of the invention can accordingly can reduce production costs and simplify manufacturing processes.

Yet another aspect of the invention provides an image forming method and an image forming apparatus using the foregoing toner. The image forming method and apparatus can provide high image resolution at low temperature fixation using the toner of the invention.

### BRIEF DESCRIPTION OF THE DRAWINGS

FIG. 1 is an electron microscope of second particles surrounding a latex aggregate.

FIG. 2 is an electron microscope showing that second particles adhere to the surface of a latex aggregate to form a shell.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

### Toner

One aspect of the invention relates to a toner having a core-shell structure prepared by an aggregation-coalescence process of latex particles having a bimodal particle size distribution.

The latex particles having a bimodal particle size distribution may have a Z-average particle size (Za) as measured by a Zetasizer instrument (by Malvern Instruments Ltd., model: Nano ZS) of about 0.09 μm<Za<about 2.0 μm. The latex particles having a bimodal particle size distribution further include first particles having a peak mean intensity (Pk1) and second particles having a peak mean intensity (Pk2) represented as follows:

about 0.10 μm<Pk1<about 3.0 μm

about 0.01 μm <Pk2<about 1.0 μm

Pk1>Pk2.

If the bimodal particle size distribution is outside of the above range, non-aggregation and overgrowth of particles may occur.

To precisely quantify the bimodal particle size distribution using the noted Zetasizer instrument, an ultrasonic dispersion of the particles can be prepared in the presence of a non-ionic surfactant for about 5 minutes, and diluted in ultra pure water in an amount sufficient to prevent reaggregation. The dilution concentration may range from about 0.01 to about 0.10% based on the total weight of the dry solid. RI (refractive index) value is based on the value of polystyrene provided by Zetasizer. The Z-average value used above is calculated using a cumulant DLS (dynamic light scattering) analysis method.

Verification of the rate of the second particles which do not participate in the aggregation may be carried out by measuring unprecipitated particle size after centrifugation of an aggregated solution with the Zetasizer instrument in the same manner as above.

Further, the first particles have a peak area intensity (Pa1) and the second particles have a peak area intensity (Pa2) represented as follows:

about 70%<Pa1<about 99%

about 1%<Pa2<about 30%

Pa1>Pa2.

The latex particles are produced by polymerizing a polymerizable monomer, and the weight average molecular weight of the latex particle may range from about 10,000 to about 300,000. The polymerizable monomer may include without limitation at least one monomer selected from styrenic monomers such as styrene, vinyl toluene and α-methyl styrene; acrylic acid; methacrylic acid; (meth)acrylic acid derivatives such as methyl acrylate, ethyl acrylate, propyl acrylate, butyl acrylate, 2-ethylhexyl acrylate, dimethylaminoethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide and methacrylamide; ethylenic unsaturated monoolefins such as ethylene, propylene and butylene; halogenated vinyls such as vinyl chloride, vinylidene chloride and vinyl fluoride; vinyl esters such as vinyl acetate and vinyl propionate; vinyl ethers such as vinyl methyl ether and vinyl ethyl ether; vinyl ketones such as vinyl methyl ketone and methyl isopropyl ketone; nitrogen containing vinyl compounds such as 2-vinyl pyridine, 4-vinyl pyridine and N-vinyl pyrrolidone; and the like, and combinations thereof.

In exemplary embodiments of the invention, the process of aggregating-coalescencing the latex particles may be conducted in the presence of colorants, charge control agents and/or waxes.

A carbon black or an aniline black may be used as the colorant for a black toner. A nonmagnetic toner according to the present invention can be easily used to prepare color toners. For color toners, a carbon black may be used as a black colorant, and one or more colorants selected from yellow, magenta, and cyan colorants may be used as a colored colorant.

Examples of yellow colorant may include without limitation condensation nitrogen compounds, isoindolinone compounds, anthraquine compounds, azo metal complex, allyl imide compounds, and the like, and combinations thereof. C.I. pigment yellow 12, 13, 14, 17, 62, 74, 83, 93, 94, 95, 109, 110, 111, 128, 129, 147, 168, 180, and the like, and combinations thereof can be used as the yellow colorant.

Examples of magenta colorant include without limitation condensation nitrogen compounds, anthraquine, quinacridon compounds, basic lake pigments, naphthol compounds, benzoimidazol compounds, thioindigo compounds, perylene compounds, and the like, and combinations thereof. C.I. pigment red 2, 3, 5, 6, 7, 23, 48:2, 48:3, 48:4, 57:1, 81:1, 122, 144, 146, 166, 169, 177, 184, 185, 202, 206, 220, 221, 254, and the like, and combinations thereof can be used as the magenta colorant.

Examples of cyan blue colorant include without limitation copper phthalocyanine compounds and derivative thereof, anthraquine compounds, basic lake pigments, and the like, and combinations thereof. C.I. pigment blue 1, 7, 15, 15:1, 15:2, 15:3, 15:4, 60, 62, 66 and the like and combinations thereof can be used as the cyan colorant.

These colorants can be used alone or in combination with one another, and the colorant may be selected based on color, chroma, brightness, weatherability, dispersibility in toner, and the like.

The amount of the colorant may range from about 0.1 to about 20 parts by weight, based on about 100 parts by weight of the polymerizable monomer. The content of the colorant may be an amount sufficient to color the toner. The coloring effect may not be sufficient when the content of the colorant is less than about 0.1 part by weight. When the content of the colorant is more than about 20 parts by weight, it may be difficult to obtain sufficient frictional electric charge since the cost of preparing the toner increases.

A charge control agent may be introduced to enhance charge-up rate and charge stability. The charge control agent may have substantially no solubility in an aqueous medium. Examples of the charge control agent may include without limitation salicylic acid compounds containing a metal, such as zinc or aluminum; metal complexes of an aromatic carboxylic acid such as dialkyl salicylate, naphtoic acid, or dicarboxylic acid; boron complexes of bisdiphenyl glycolic acid; silicate compounds; calixarenes; and the like, and combinations thereof. Zinc dialkyl salicylate or borobis(1,1-diphenyl-1-oxo-acetyl) potassium salt may be used.

The wax may be any wax that is known in the art and suitable waxes are commercially available. Examples of the wax may include, but are not limited thereto, polyethylenic wax, polypropylenic wax, silicon wax, paraffinic wax, ester wax, camauba wax, metallocene wax, and the like, and combinations thereof. The melting point of the wax may range from about 50 to about 150° C. The wax component physically adheres to the toner particles, but does not covalently bond with the toner particles. The wax is fixed on the final image receptor at a low fixation temperature. The wax can provide the toner with superior final image durability and an anti-abrasion property by preventing hot offset by functioning as a release agent.

The toner composition of the present invention may further include a release agent (which can be the same or different from the waxes described herein). The release agent can be a high-purity solid fatty acid ester. Examples of the release agent can include without limitation low molecular weight polyolefins, such as low molecular weight polyethylene, low molecular weight polypropylene, low molecular weight polybutylene and the like; paraffin wax; multi functional ester compounds; and the like, and combinations thereof. The release agent can be, for example, a multi functional ester compound prepared from the reaction of tri- or higher functional alcohols and carboxylic acids. Alcohols with three or more functional groups include without limitation aliphatic alcohols such as glycerin, pentaerithritol, pentaglycerol, and the like; cycloaliphatic alcohols such as chloroglycitol, quercitol, inositol, and the like; aromatic alcohols such as tris(hydroxymethyl)benzene and the like; sugars such as D-erythrose, L-arabinose, D-mannose, D-galactose, D-fructose, L-rhamnose, sacharose, maltose, lactose, and the like; and sugar alcohols such as erythrite, D-trehalose, L-arabite, adonitol, xylitol, and the like; and combinations thereof. Carboxylic acids include without limitation aliphatic carboxylic acids such as acetic acid, butyric acid, caproic acid, enanthic acid, caprylic acid, pelargonic acid, capric acid, undecanoic acid, lauric acid, myristic acid, stearic acid, margaric acid, arachidic acid, cerotic acid, merichisinic acid, eicosenoic acid, valeric acid, sorbic acid, linolic acid, linolenic acid, behenic acid, tetrolic acid, xymenic acid, and the like; cycloaliphatic carboxylic acids such as cyclohexane carboxylic acid, hexahydroisophthalic acid, hexahydroterephthalic acid, 3,4,5,6-tetrahydrophthalic acid, and the like; aromatic carboxylic acids such as benzoic acid, troic acid, cumic acid, phthalic acid, isophthalic acid, terephthalic acid, trimesic acid, trimellitic acid, hemimellitic acid, and the like; and combinations thereof.

The toner according to the present invention may have core-shell structure formed by using latex particles with a bimodal particle size distribution. Generally, the core of the core-shell structure primarily includes the first particles, which are first to aggregate, as discussed herein. The core also includes colorant, charge control agent, wax, and/or release agent. Generally, the shell surrounds the core and primarily includes the second particles, which participate in the aggregation after the first particles. Although the core and shell are substantially comprised of first and second particles, respectively, the core may include a minority amount of second particles and/or the shell may include a minority amount of first particles.

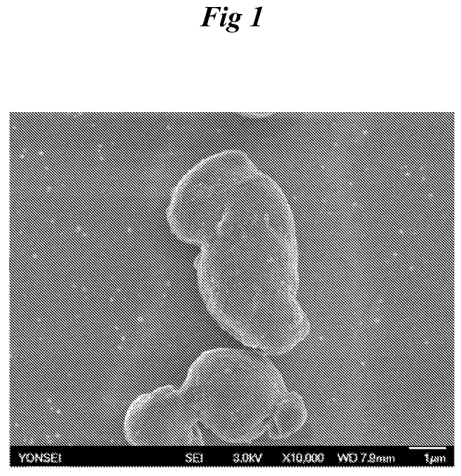

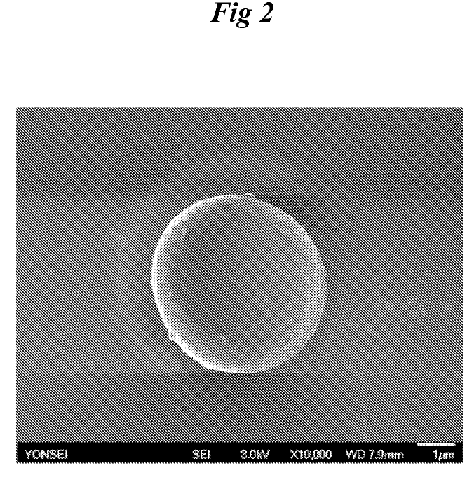

FIG. 1 is an electromicroscopic picture of second particles surrounding a latex aggregate. FIG. 2 is an electromicroscopic picture showing that second particles form a shell by adhering to the surface of latex aggregate.

### Method for Preparing the Toner

The toner can be prepared by aggregating and coalescing latex particles having a bimodal particle size distribution with a colorant and a wax.

The Z-average particle size of the latex particles having a bimodal particle size distribution, peak mean intensity and peak area intensity of the first and second particles have already been mentioned in the foregoing.

The latex particles are produced by polymerization of a polymerizable monomer, and the polymerizable monomer is already mentioned in the foregoing.

The method of the present invention can overcome problems associated with conventional emulsion-aggregation toners such as tribo-charge susceptibility to environmental conditions (such as humidity and temperature) and decreased adhesiveness or fixation between paper and toner under high humidity conditions. The above problems can result from reduced fluidity and electrification of the particles due to the presence of components other than high molecular latex such as pigments used in emulsion-aggregated toner, and reduced fixation due to reduced aggregation of the particles in a fixation process.

The rate of the total aggregate system may be inversely proportional to the size of the first latex particles. The second particles do not participate in an initial aggregation but do participate in aggregation later than the first latex particles, colorants, charge control agent and wax. Accordingly, a shell-structure can be achieved without requiring a separate latex for the shell by using the bimodal latex.

Aggregation rate can be controlled by adjusting pH and ionic strength. The size and shape of a toner can be controlled by controlling reaction conditions, such as temperature, heating time, stirring rate, and the like. The toner of the invention may be prepared under conditions known in the art, and the skilled artisan will appreciate and understand appropriate aggregation-coalescence conditions such as pH, ionic strength, temperature, heating time, stirring rate, and the like.

In exemplary embodiments of the invention, the latex particles comprising the colorant, the charge control agent and the wax can be aggregated by adjusting pH or adding an inorganic salt, for example, sodium salt such as NaCl, Na₂SO₄ and Na₂CO₃, or magnesium salt such as MgCl₂ and MgSO₄ at the initial stage of aggregation. Other color salts such as FeSO₄, Fe₃(SO₄)₂ and the like may be used for black toner.

In the aggregation, if the pH increases by adding an alkali, surfaces of the particles are changed to have negative charges, or positive charges occupy relatively less of the particle surfaces. Changing the particle surfaces into the negative charges is mainly caused by the existence of macromonomer chains chemically bonded to the surfaces, a sulfate group of an initiator such as potassium persulfate (KPS), and an acid group used as a co-monomer.

If the particles have a high negative charge value, i.e., a high pH or a high zeta potential value, the aggregation does not actively proceed because of increasing repulsive forces. On the other hand, if the pH or the zeta potential value is low, the dispersion stability of the particles may decrease, which can result in irregular (or no) aggregation and non-uniform particle size distribution. If the concentration of the electrolyte or the inorganic salt is higher than a critical coagulation concentration, the electrostatic repulsion is compensated and then the aggregation proceeds rapidly by Brownian motion of the latex particles. If the concentration is lower than a critical coagulation concentration, the coagulation will occur slowly.

The step of aggregation may further comprise the step of controlling ionic strength by adding an electrolyte or inorganic salt.

In the aggregation step, the size of the particles may be enlarged by ionic strength and collision among the particles.

In exemplary embodiments of the invention, the polymer latex can be aggregated by heating the latex to a temperature less than the glass transition temperature (Tg) of the latex particles. In other exemplary embodiments of the invention, the polymer latex can be aggregated by heating the latex to the Tg of the latex or higher. When the polymer latex is aggregated at a temperature of Tg or less, the aggregation process may simultaneously proceed with the aggregation and/or coalescence at a temperature of Tg or more. Above the latex Tg temperature, the Gibbs free energy of the latex particles may increase, so that a smooth surface of the toner can be obtained. It is also possible to control the shape of the particles according to temperature conditions.

The morphological difference of the toner particles results from the interfacial tension and rheology of the particles. After obtaining a desired size and shape of the particles, the toner particles are cooled to a temperature of Tg of the latex or less, separated through filtration, and dried. External additives such as silica are externally added to the dried toner. Finally a toner suitable for electrophotographic development in laser printers, photocopiers and the like can be obtained by controlling the electrified charge.

The toner obtained therefrom may have a core-shell structure, and the median cumulative volume (D50) of the toner may be about 4 to about 9 μm. In the present invention, the second particles participate in the aggregation late. Thus, it is possible to prepare core-shell toner particles simply without an additional step of preparing a latex for the shell.

The aggregated toner can be separated and dried, and then silica may be externally added, followed by controlling electric charge to obtain a final toner.

The toner obtained in accordance with the invention can be used in an image forming method. In one embodiment, the method comprises forming a visible image by adhering a toner of the invention to a surface of a photoreceptor on which an electrostatic latent image is formed and transferring the visible image to a transfer material. In general, an electro-photographic image forming process comprises a series of steps forming the image on a photoreceptor, including charging (electrificating), light exposing, developing, transferring, fixing, cleaning, and charge removing (erasing) steps.

In the charging (electrificating) step, the photoreceptor is typically positively or negatively charged as desired by means of a corona or charge (electrifying) roller. In the present invention, a charger (electrifier) in the form of a charge (electrifying) roller can be used. In the light exposing step, an optical system, typically a laser scanner or diode arrangement, selectively discharges the charged (electrified) surface of the photoreceptor in an imagewise manner corresponding to a target image formed on a final image receptor to form the latent image. Electromagnetic irradiation referred to herein as “light” may include laser irradiation, infrared irradiation, visible light, and UV irradiation.

In the developing step, the toner particles with desirable charge generally contact the latent image on the photoreceptor. Typically, an electrically-biased developer having the same potential polarity as the toner may be used. The toner particles move to the photoreceptor, selectively adhere to the latent image by static electricity, and then form the toner image on the photoreceptor.

In the transferring (transcribing) step, the toner image may be transferred (transcribed) to the final image receptor. Sometimes, an intermediate transferring (transcribing) element can be used to effect transfer (transcription) of the toner image from the photoreceptor to the final image receptor.

In the fixing step, the toner image on the final image receptor may be heated to soften or melt the toner particles, and fixed on the final image receptor. Alternatively, the toner may be fixed on the final receptor under high pressure with or without heating. In the present invention, fixation property was measured by attaching and detaching 3M magic tape. Fusing latitude is measured using a fixing jig at 5° C. intervals in the range of 120 to 200° C.

In the cleaning step, the remaining toner on the photoreceptor is removed. Residual (remaining) toner may cause defects in an image such as positive memory and negative memory. Accordingly, the developing step can be conducted substantially simultaneously with the cleaning step using a suitable cleaning system or cleanerless system to thoroughly remove waste toner. Polymerized toner can reduce the production of waste toner.

Finally, in the charge removing step, the charge of the photoreceptor may be exposed to light of a specific wavelength band to lower the charge to a substantially uniform low level, so the remaining materials of the original latent image may be removed. Then, the photoreceptor can be prepared for the next image forming cycle.

The toner according to the present invention can be used with an image forming apparatus which comprises an organic photoreceptor (OPC), means for electrifying the surface of the OPC, means for forming an electrostatic latent image on the surface of the OPC, means for receiving a toner, means for developing a toner image by supplying the toner and developing the electrostatic latent image on the surface of the OPC, and means for transferring (transcribing) the toner image from the surface of the OPC to a transfer material.

The image forming apparatus according to the present invention can include means for charging (electrifying) a photoreceptor; means for exposing the electrified photoreceptor to form a latent image on the photoreceptor; developing means for contacting the toner of the invention with the latent image on the photoreceptor to form a toner image; means for transferring (transcribing) the toner image from the photoreceptor to a final image receptor; means for fixing the toner image on the final image receptor by heating the final image receptor transcribed the toner image to soften or to melt the toner; and cleaning means for removing the remaining toner from the photoreceptor.

The present invention will be discussed in detail in the following examples, and the following examples are to illustrate, but not to limit, the scope of the appended claims.

### EXAMPLES

### Example 1

407 g of de-ionized water, carbon black (Mogul-L, DIC), wax (Esterwax, WE-3 and WE-8) and 246 g of a styrene-acryl copolymer latex are introduced into a IL reactor and stirred using a plate impeller at 150 rpm for 10 minutes. After stirring, the pH is adjusted to 10 and a 0.05 M MgCl₂ solution is added. Then, aggregation-coalescence is conducted for 4 hours by increasing the temperature up to 85° C. The latex is shown in Table 1. Thereafter, the pH is adjusted to 9 and the solution is gradually heated. When a particle shape is formed after heating about 6 hours, the solution is cooled and filtered to obtain toner particles. The properties of the resultant particles are shown in Table 2.

### Example 2

407 g of de-ionized water, yellow pigment (YX-101, DIC), wax (Esterwax, WE-3 and WE-8) and 246 g of a styrene-acryl copolymer latex are introduced into a IL reactor and stirred using a plate impeller at 150 rpm for 10 minutes. After stirring, the pH is adjusted to 9 and a 0.05 M MgCl₂ solution is added. Then, aggregation-coalescence is conducted by gradually increasing the temperature up to 90° C. When the particle size is 5.0 to 5.5 μm, the pH is adjusted to 11 and aggregation-coalescence is conducted. The latex is shown in Table 1. When a particle shape is formed after heating for about 7 hours, the solution is cooled and filtered to obtain toner particles. The properties of the resultant particles are shown in Table 2.

### Example 3

Particles are prepared in the same manner as in Example 1, except that a latex used in example 2 is as shown in Table 1. The properties of the resultant particles are shown in Table 2.

### Comparative Example 1

Styrene-(n-butyl acrylate) copolymer latex particles prepolymerized using emulsifier as shown in Table 1 is used. 346 g of latex particles are introduced into 407 g of ultra pure water and stirred at 30° C. Then, SDS emulsifier is added to a carbon black (Mogul-L, DIC) dispersion and wax (Esterwax, WE-3 and WE-8) dispersion and all are mixed. Stirring at 200 rpm, the latex pigment dispersion is titrated with 10% NaOH buffer solution until the pH is adjusted to 10. After 10 g of a flocculant MgCl₂ is dissolved in 30 g of ultra pure water, the solution is added to the latex pigment solution for 10 minutes and the temperature is raised to 95° C. When the desired particle is obtained after heating for about 4 hours, the reaction is terminated and cooled. The properties of the resultant particles are shown in Table 2.

### Comparative Example 2

Particles are prepared in the same manner as in Example 1 except that a latex is used as shown in Table 1. The properties of the resultant particles are shown in Table 2.

TABLE 1

| | | | | | Comparative | |
|---|---|---|---|---|---|---|
| Composition of Aggregation- | | Examples | | | Example | |
| Coalescence | | 1 | 2 | 3 | 1 | 2 |
| High | Z-Average | 371 | 410 | 430 | 409 | 562 |
| molecular | (nm) | | | | | |
| latex | Pk1 (nm) | 493 | 525 | 654 | 614 | 1000 |
| | Pk2 (nm) | 96 | 104 | 129 | — | 273 |
| | Pa1 (%) | 94.6 | 96.8 | 87.3 | 100.0 | 64.9 |
| | Pa2 (%) | 5.4 | 3.2 | 12.7 | — | 35.1 |
| Mogul-L | wt % | 5.0 | — | 5.0 | 5.0 | 5.0 |
| YX-101 | wt % | — | 5.0 | — | — | — |
| WE-3 | wt % | 2 | 1 | 1 | 1 | 2 |
| WE-8 | wt % | 3 | 4 | 4 | 4 | 3 |

TABLE 2

| | | | | | Comparative | |
|---|---|---|---|---|---|---|
| Condition of Aggregation- | | Examples | | | Example | |
| Coalescence | | 1 | 2 | 3 | 1 | 2 |
| Aggregated | D50 (vol, μm) | 6.9 | 6.5 | 5.8 | 9.8 | 7.7 |
| toner | C.V. % | 19 | 21 | 28 | 21 | 42 |
| Adhesivity | % | 5.0 | 5.0 | 5.0 | 5.0 | 5.0 |
| Adhesive | ° C. | 130~200 | 135~200 | 140~190 | 135~180 | 155~175 |
| area | | | | | | |
| Blow-off | μC/g | −25 | −22 | −18 | −14 | −8 |

In the above table:

C.V. % (coefficient of variation): standard variation of total particle size distribution/average particle diameter. Smaller C.V. % values are preferred.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A toner having a core-shell structure prepared by an aggregation-coalescence process of latex particles having a bimodal particle size distribution.

2. The toner of claim 1, wherein the latex particles having a bimodal particle size distribution have a Z-average particle size (Za), first particles having a peak mean intensity (Pk1) and second particles having a peak mean intensity (Pk2) as follows:
about 0.09 μm<Za<about 2.0 μm
about 0.10 μm<Pk1<about 3.0 μm
about 0.01 μm<Pk2<about 1.0 μm
Pk1>Pk2.

3. The toner of claim 2, wherein the first particles have a peak area intensity (Pa1) and the second particles have a peak area intensity (Pa2) as follows:
about 70%<Pa1<about 99%
about 1%<Pa2<about 30%
Pa2>Pa2.

4. The toner of claim 1, wherein said latex particles are prepared by polymerizing at least one polymerizable monomer comprising a styrenic monomer; acrylic acid; methacrylic acid; (meth)acrylic acid derivative; ethylenic unsaturated monoolefin; halogenated vinyl; vinyl ester; vinyl ether; vinyl ketone; nitrogen containing vinyl compound; or a combination thereof.

5. The toner of claim 4, wherein said styrenic monomer comprises styrene, vinyl toluene, α-methyl styrene, or a combination thereof; said (meth)acrylic acid derivative comprises methyl acrylate, ethyl acrylate, propyl acrylate, butyl acrylate, 2-ethylhexyl acrylate, dimethylaminoethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, methacrylamide, or a combination thereof; said ethylenic unsaturated monoolefin comprises ethylene, propylene, butylene, or a combination thereof; said halogenated vinyl comprises vinyl chloride, vinylidene chloride, vinyl fluoride, or a combination thereof; said vinyl ester comprises vinyl acetate, vinyl propionate, or a combination thereof; said vinyl ether comprises vinyl methyl ether, vinyl ethyl ether, or a combination thereof; said vinyl ketone comprises vinyl methyl ketone, methyl isopropyl ketone, or a combination thereof; and said nitrogen containing vinyl compound comprises 2-vinyl pyridine, 4-vinyl pyridine, N-vinyl pyrrolidone, or a combination thereof.

6. The toner of claim 1, wherein said aggregation-coalescence process of latex particles is conducted with the use of colorants, charge control agents and waxes.

7. The toner of claim 6, wherein the core comprises the first particles, colorant, charge control agent and wax, and the shell comprises the second particles.

8. A method for preparing a toner comprising aggregating and coalescing latex particles having a bimodal particle size distribution with a colorant and a wax.

9. The method of claim 8, wherein the latex particles having a bimodal particle size distribution have a Z-average particle size (Za), first particles having a peak mean intensity (Pk1) and second particles having a peak mean intensity (Pk2) as follows:
about 0.09 μm<Za<about 2.0 μm
about 0.10 μm<Pk1<about 3.0 μm
about 0.01 μm<Pk2<about 1.0 μm
Pk1>Pk2.

10. The method of claim 9, wherein the first particles have a peak area intensity (Pal) and the second particles have a peak area intensity (Pa2) as follows:
about 70%<Pa1<about 99%
about 1%<Pa2 <about 30%
Pa1>Pa2.

11. The method of claim 8, further comprising adjusting the pH of the latex to control the rate of said aggregating step.

12. The method of claim 8, further comprising controlling ionic strength during said aggregating and coalescing step by adding electrolytes or inorganic salts to the latex.

13. The method of claim 8, wherein aggregating-coalescing of the latex particles comprises heating the latex particles to the glass temperature (Tg) of the latex particles or higher.

14. The method of claim 8, further comprising aggregating-coalescing the latex particles in the presences of a release agent.

15. An image forming method comprising the steps of:
charging a photoreceptor;
forming a latent image on the photoreceptor by exposing said charged photoreceptor to light;
forming a toner image by contacting toner of claim 1 with said latent image on the photoreceptor;
transferring said toner image from the photoreceptor to a final image receptor;
fixing the toner on said final image receptor by heating said final image receptor with said transferred toner image and softening and/or melting the toner; and
removing remaining toner from said photoreceptor.

16. An image forming apparatus comprising:
means for charging a photoreceptor;
means for exposing the charged photoreceptor to form a latent image on said photoreceptor;
developing means for contacting a toner according to claim with the latent image on the photoreceptor to form a toner image;
means for transferring said toner image from the photoreceptor to a final image receptor;
means for fixing the toner image on the final image receptor by heating the final image receptor with the toner image to soften or to melt the toner; and
cleaning means for removing the remaining toner from the photoreceptor.
